(19) United States
(12) Patent Application Publication
(10) Pub. No.: US 2006/0276585 A1
(43) Pub. Date: Dec. 7, 2006

(54) Crosslinkable compositions based on organosilicon compounds

(75) Inventor: Anette Lork, Essen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Chemie AG, Munich (DE)

(21) Appl. No.: 11/446,994

(22) Filed: Jun. 5, 2006

(30) Foreign Application Priority Data
Jun. 6, 2005 (DE) 10 2005 025 915.4

(51) Int. Cl. C08L 83/04; D06M 15/643; B32B 27/14

(52) U.S. Cl. 524/588; 428/447; 428/405; 252/8.61

(57) ABSTRACT

A low friction composition containing addition-crosslinking organosilicon compounds, at least one oval to sphere-shaped solid and at least one laminar solid, and at least one component which is: a hydrocarbyl compound having at least 8 carbon atoms, optionally containing heteroatoms; a silane of the formula
(RO)₄₋ₙSiXₙ
where R is a monovalent C₁₋₁₆ hydrocarbyl radical and X is R or is a functional C₁₋₁₆ hydrocarbyl radical linking an epoxy or methacryloyloxy organic functional group and the silicon atom, an organozirconium or organotitanium compound of the formula (RO)₄₋ₙMXₙ where R and X are as defined above and M is Ti or Zr; and optionally, (4) an organic solvent.

### BACKGROUND OF THE INVENTION

1. Field of the Invention

The invention pertains to crosslinkable compositions based on organosilicon compounds and textile and nontextile sheetlike and molded articles produced therefrom.

2. Background Art

Crosslinkable compositions based on organosilicon compounds have been extensively described with various kinds of fillers and additives. For instance, EP 1 152 080 A2 describes spherical particles fixed in thin adhesive layers on textile fabrics, specifically to reduce friction against the skin. EP 0 953 675 A2 and WO 01/128 95 A1 describe predominantly laminar fillers/particles in textile coatings to achieve low coefficients of friction. Further, substantially laminar, flakelike fillers for friction reduction are described in DE 102 113 14.

It is now known, however, that the frequently recommended laminar extenders, when used as fillers, have a significantly adverse effect on the adhesion of rubbers. WO 01/12895 A1 describes the marked deterioration in the physical properties of elastomeric coatings due to laminar fillers, as a result of which the use of thus filler-modified coatings which is described in EP 0 953 675 A2 is now merely limited to application as a topcoat. The use of laminar to flakelike fillers for minimizing the friction coefficients of crosslinkable compositions and coatings recommended in DE 102 113 14 resulted in unwanted effects and also unsatisfactory processibility.

EP 0 712 956 describes a coating with spherical, organic/inorganic components which, depending on the particle size, likewise lead to a deterioration in coating properties. Moreover, solvent is a necessary constituent for homogenizing the spherical components.

### SUMMARY OF THE INVENTION

It is an object of the present invention to improve the state of the art, in particular to provide textile fabrics or, in general, other substrates coated with silicone rubber which have special surface properties. Unlike the usually tacky-feeling surfaces of customary rubbers, there is frequently a demand for surfaces having a soft, dry feel or hand and hence an attendant low coefficient of friction. An important requirement in particular is the reduction in friction in the case of certain rubber materials (examples being wiper blades, soft-touch applications, nonblocking seals) or of rubber coatings on airbag fabrics. More particularly, rapid deployment of airbags requires friction due to textile rubbing against textile to be minimized. These and other objects are provided by crosslinkable organopolysiloxane compositions containing both spherical and laminar fillers, and specific additives.

### DETAILED DESCRIPTION OF THE PREFERRED EMBODIMENT(S)

The frequently desired good silicone rubber properties of crosslinkable compositions or coatings, for example, very good mechanics, high elasticity, good thermal resistance, can be decisively improved either through specific modification of the rubber compositions or coatings themselves or through thin topcoats on silicone rubber basecoats for surface modification. Given good adhesion on the part of the topcoat, the coefficient of friction of the mechanically good rubber basecoats and their flammability could be reduced coupled with a possible increase in the Shore hardness and significant improvement in the hand properties and the coefficient of friction of the vulcanizate.

The present invention accordingly provides a composition comprising:
(A, B) addition-crosslinking organosilicon compounds
(C) hydrosilylation catalyst
(D) at least one oval to sphere-shaped solid and at least one laminar solid
and further at least one component (E) from the following group:
(1) hydrocarbyl compound(s) having at least 8 carbon atoms, with or without interruption of the hydrocarbyl skeleton by heteroatoms such as N, O, P or S, the free valences of the heteroatoms being saturated by hydrogen or monovalent hydrocarbyl radicals;
(2) silane(s) of the general formula
   (RO)₄₋ₙSiXₙ
   where R is a monovalent hydrocarbyl radical having up to 16 carbon atoms and X independently of R has the meaning of R or is a functional hydrocarbyl radical having 1 to 6 carbon atoms between the organic functional group and the silicon atom and the organic functional group is selected from epoxy and methacryloyloxy groups;
(3) an organozirconium or organotitanium compound of the general formula
   (RO)₄₋ₙMXₙ
   where R and X are each as defined above and M is Ti or Zr;
   optionally:
(4) an organic solvent;
   the coefficient of friction of the vulcanizate being reduced compared with a composition without particles (D).

The adhesion of the composition of the present invention is at least comparable to, and preferably better than that of a composition that includes only mica or talc.

Preferably the organosilicon compounds (A) are linear, cyclic or branched siloxanes consisting of units of the formula
R²ₛR³ₜSiO_{(4-s-t)/2}
where
R² in each occurrence may be the same or different and is an SiC bonded aliphatically unsaturated hydrocarbyl radical,
R³ in each occurrence may be the same or different and is an optionally substituted SiC-bonded aliphatically saturated hydrocarbyl radical,
s is 0, 1, 2 or 3, preferably 0, 1 or 2, and
t is 0, 1, 2 or 3, with the proviso that the sum total s+t is not more than 3 and two or more R² radicals are present per molecule.

The organosilicon compounds (A) preferably have an average viscosity in the range from 500 to 100,000 mPas at 25° C.

Preferably, R² represents hydrocarbyl radicals of 2 to 18 carbon atoms having aliphatic multiple bonding, such as vinyl, allyl, methallyl, 2-propenyl, 3-butenyl, 4-pentenyl, 5-hexenyl, butadienyl, hexadienyl, cyclopentenyl, cyclopentadienyl, cyclohexenyl, ethynyl, propargyl and 2-propynyl, this kind of R² radical with 2 to 6 carbon atoms being particularly preferred, especially vinyl and allyl.

Preferably R³ represents optionally substituted aliphatically saturated monovalent hydrocarbyl radicals having 1 to 18 carbon atoms, more preferably having 1 to 8 carbon atoms, especially methyl.

Examples of R³ radicals are alkyl radicals such as the methyl, ethyl, n-propyl, isopropyl, 1-n-butyl, 2-n-butyl, isobutyl, tert-butyl, n-pentyl, isopentyl, neopentyl, and tert-pentyl radicals; hexyl radicals such as n-hexyl; heptyl radicals such as n-heptyl; octyl radicals such as n-octyl and isooctyl such as 2,2,4-trimethylpentyl; nonyl radicals such as n-nonyl; decyl radicals such as n-decyl; dodecyl radicals such as n-dodecyl; octadecyl radicals such as n-octadecyl; cycloalkyl radicals such as cyclopentyl, cyclohexyl, cycloheptyl and methylcyclohexyl radicals; alkenyl radicals such as vinyl, 1-propenyl and 2-propenyl radicals; aryl radicals such as phenyl, naphthyl, anthryl and phenanthryl; alkaryl radicals such as o-, -, p-tolyl radicals, xylyl radicals and ethylphenyl radicals; and aralkyl radicals such as the benzyl, α-phenylethyl and β-phenylethyl radicals.

More preferably the organosilicon compounds (A) are linear organopolysiloxanes having a viscosity in the range from 1000 to 100,000 mpas at 25° C., of the structure:
(ViMe₂SiO_{1/2}) (ViMeSiO)₀₋₅₀(Me₂SiO)₃₀₋₂₀₀₀(ViMe₂SiO_{1/2}),
where Me is methyl and Vi is vinyl.

Useful organosilicon compounds having Si-bonded hydrogen atoms are preferably linear, cyclic or branched siloxanes consisting of units of the formula
R⁴ᵤHᵥSiO_{(4-u-v)/2}
where
R⁴ in each occurrence may be the same or different and has a meaning indicated above for R³,
u is 0, 1, 2 or 3, and
v is 0, 1 or 2, preferably 0 or 1,
with the proviso that the sum total of u+v is not more than 3 and there are on average two or more Si-bonded hydrogen atoms per molecule.

The organosilicon compounds (B) preferably have a viscosity in the range from 10 to 2×10⁴ mPas at 25° C.

Preference is given to the use of an organosilicon compound (B) containing three or more SiH bonds per molecule. On use of a constituent (B) having only two SiH bonds per molecule, the organosilicon compound (A) preferably contains at least three aliphatic carbon-carbon multiple bonds per molecule. The organosilicon compound (B) is thus preferably employed as a crosslinker.

The organosilicon compound (B) has an Si-bonded hydrogen content of preferably 0.002% to 1.7% by weight of hydrogen and more preferably between 0.1% and 1.7% by weight of hydrogen. More preferably the organosilicon compounds (B) are organopolysiloxanes having a viscosity in the range from 10 to 800 mPas at 25° C.

The polyorganosiloxane (B) is preferably present in the curable silicone rubber composition in an amount such that the molar ratio of SiH groups to radicals having aliphatic carbon-carbon multiple bonding of component (A) is between 0.5 and 5 and more preferably between 1.0 and 3.0.

Constituent (C), which promotes the addition reaction (hydrosilylation) between the radicals having aliphatic carbon-carbon multiple bonding and Si-bonded hydrogen in the compositions of the present invention can be any hydrosilylation catalyst. Examples of hydrosilylation catalysts (C) are metals such as platinum, rhodium, palladium, ruthenium and iridium, preferably platinum, which may optionally be immobilized on finely divided support materials, such as activated carbon, alumina or silica. Preferably catalyst (C) is platinum or a compound or complex thereof.

The amount of catalyst (C) depends on the desired crosslinking rate, the particular use, and also economic aspects. The compositions of the present invention preferably include catalysts (C) in such amounts that a platinum content of 0.05 to 500 weight ppm (parts by weight per million parts by weight), more preferably 0.5 to 100 weight ppm and especially 1 to 50 weight ppm, all based on the total weight of the crosslinkable composition, is obtained.

(D) The composition of the present invention utilizes at least an oval to sphere-shaped solid and a laminar solid. An additional filler such as a nonreinforcing, or preferably, a reinforcing filler, is similarly possible.

Suitable spherical-oval solids are selected from the group of the silicon oxides and metal oxides, from purely organic compounds, or from organosilicon compounds, but preferably from mixed metal oxides with other metals or semimetals. With regard to metal oxides, oxides of the metals aluminum, titanium, zirconium, tantalum, tungsten, hafnium, zinc, and tin are preferred. In relation to the silicon oxides, colloidal silicas and precipitated silicas are preferred. In relation to metal oxides, aluminas such as corundum, mixed aluminum oxides with other metals and/or silicon, titanias, zirconias, and iron oxides are particularly preferred.

Among the oval to spherical, or sphere-shaped, solids used as an effect filler are those which differ in the thickness of their wall material. They may be thin-walled hollow spheres or microcapsules providing the option of taking up a fluid of active component, multilayered walling structures, core-shell structures, thick-walled hollow spheres or solid spheres having particle sizes in the nanometer or micrometer range, or consisting of mixtures of the latter.

The oval to sphere-shaped solids may be inorganic, xenomorphous, hypidiomorphous, microcrystalline, cristallite like X-ray amorphous to amorphous or consist of mixed forms of different intergrowths/aggregations, and may be not only monophasic but also polyphasic. Spheres, microspheres or nanospheres consisting of borosilicate glass, technical grade glass, pure SiO₂ glass, of calcium carbonate or of ceramic compositions, preferably aluminosilicatic such as for example mullitic, are similarly possible. For example, functional groups can also be achieved through treatment of the solids with functional silanes such as vinyltrialkoxysilanes, vinyltriacetoxysilanes, glycidoxypropyltrialkoxysilanes or methacryloyloxypropyltrialkoxysilanes, which can be applied in accordance with the prior art. Examples of further organofunctional groups are acryloyl groups, epoxy groups, hydroxyl groups, and alkoxy groups.

It is also possible for polymeric organic particles or powders having particle sizes in the nanometer to micrometer range or mixtures of the latter to be included, examples being those consisting of vinyl acetate-ethylene copolymers, polyacrylonitrile powders, acrylates or styrene-acrylates. Preference is given to particles consisting of organosilicon compounds which are spherical solid silicone resins, preferably MQ resins, TD resins having glass transition points of around 30° C. and/or silicone elastomers, which may also include functional groups and which, if appropriate have been applied by methods in accordance with the prior art.

The spherical fillers used according to the present invention have a diameter in the range from 0.01 to 100 μm, preferably in the range from 1 to 40 μm and more preferably in the range from 2 to 25 μm.

(2) The laminar solids necessarily present in (D) comprise at least one material selected from natural phyllosilicates such as mica or clay minerals including their calcined variants, from synthetic solids such as metal or glass flakes or platelet-shaped metal oxides/hydroxides or tectosilicates such as leaf zeolites. Examples of natural phyllosilicates are the three-layer silicates of the talc pyrophyllite group, the di- to trioctahedral three-layer silicates of the mica group such as muscovite, paragonite, phlogopite, and biotite, the four-layer silicates of the chlorite group and representatives of the clay mineral group, such as kaolinite, montmorillonite, and illite.

The laminar fillers used according to the present invention in (D) may be partly untreated or surface treated with functional silanes, whereby a slight reinforcing effect can be achieved. Examples of functional silanes with which the fillers can be surface treated are vinyltrialkoxysilanes, vinyltriacetoxysilanes, glycidoxypropyltrialkoxysilanes or methacryloyloxypropyltrialkoxysilanes. Mono-, di- und tetraalkoxysilanes, which may bear organic functions in addition to the alkoxy function, are likewise useful.

Laminar solids, given sufficient delamination, are always characterized in that their length is numerically greater than their thickness. Depending on whether they are natural sheet-silicates or the preferably calcined variants, the thickness is customarily 10 to 20 times smaller than their length. The slightly reinforcing laminar solids used according to the present invention have a particle length of 0.01 to 80 μm, preferably 0.1 to 20 μm, and more preferably 0.8 to 20 μm.

(3) (D) may further comprise a reinforcing solid combined with the laminar solid that has a high specific surface area >50 m²/g or a high oil number >100, with the premise that a viscosity increase for the crosslinkable composition due to the reinforcing fractions is minimized.

Reinforcing fillers may also include diverse nanoscale components: aluminosilicates, calium carbonate, preferably silicon dioxide. Examples of particularly preferred reinforcing fillers are pyrogenic or precipitated silicas having BET surface areas of at least 50 m²/g and also furnace black and acetylene black, the specified silicas having hydrophilic character or being hydrophobicized by known processes. Typical examples of reinforcing solids possessing high oil absorption are diatomaceous earths, which can be used in calcined or preferably in natural form.

The laminar and an additionally reinforcing solid in (D) can be present in weight ratios of 2:1 and 1:2, preferably in a ratio of 1:1.

The compositions of the present invention are characterized in that the fraction, in the crosslinkable composite composition, of all particulate solids present is not less than 15%, preferably in the range from 30% to 50% and more preferably in the range from 50% to 85%, all based on 100 parts by weight of the total formulation.

It has been determined that the ratio of laminar:oval to spheric solids in the crosslinkable composition can vary in the range from 1:20 to 20:1, preferably is 1:10 to 10:1 in order to counteract any reduction in the adhesion due to laminar fractions. The identity, use amount and functionalization of the laminar solid present is chosen such that, combined with ideally superior adhesion values, the coefficient of friction is at least equivalent to that of precisely such a composition (D) featuring a higher level of natural sheet-silicates, such as talc or mica.

The ratio of spherical solid to laminar solid including any additional, preferably reinforcing solid which differs therefrom can, in principle be 1:1, but preferably is 3:1 and more preferably 6:1.

The composition of the present invention includes at least one component (E) from the following group:

Examples (1) of organic compounds (E) are hydrocarbyl compounds having at least 8 carbon atoms with or without interruption of the hydrocarbyl skeleton by heteroatoms such as N, O, P or S, the free valences of the heteroatoms being saturated by hydrogen or monovalent hydrocarbyl radicals.

Examples (2) and preferably of (E) are organosilicon compounds (E), such as a silane of the general formula:
(RO)₄₋ₙSiXₙ
where R is a monovalent hydrocarbyl radical having up to 16 carbon atoms and X independently of R has the meaning of R or is a functional hydrocarbyl radical having 1 to 6 carbon atoms between the organic functional group and the silicon atom and the organic functional group being selected from epoxy and methacryloyloxy.

Examples (3) of an organometallic compound (E) is an organozirconium or organotitanium compound of the general formula:
(RO)₄₋ₙMXₙ
where R and X are each as defined above and M is Ti or Zr.

The compounds (E) are present in the composition in amounts based on the total composition ranging from 0.05% to 15%, preferably 0.1%-7% and more preferably 0.5% to 5%.

In addition to the components (A) to (E), the curable compositions of the present invention may further comprise all further auxiliaries (F) hitherto used for preparing addition-crosslinkable compositions with the proviso that the further materials (F) differ from components (A), (B), (C) and (D).

Examples of further materials (F) are reinforcing fillers, nonreinforcing fillers, resinous polyorganosiloxanes other than the siloxanes (A) and (B), dispersing assistants, solvents, viscosity modifiers, adhesion promoters, pigments, dyes, plasticizers, organic polymers, thermostabilizers, inhibitors and stabilizers.

Examples of customary inhibitors useful as component (F) are acetylenic alcohols, such as 1-ethynyl-1-cyclohexanol, 2 methyl-3-butyn-2-ol and 3,5-dimethyl-1-hexyn-3-ol, 3-methyl-1-dodecyn-3-ol, polymethylvinylcyclosiloxanes, such as 1,3,5,7-tetravinyltetramethyltetracyclosiloxane, tetravinyldimethyldisiloxane, trialkyl cyanurates, alkyl maleates, such as diallyl maleates, dimethyl maleate and diethyl maleate, alkyl fumarates, such as diallyl fumarate and diethyl fumarate, organic hydroperoxides, such as cumene hydroperoxide, tert-butyl hydroperoxide and pinane hydroperoxide, organic peroxides, organic sulfoxides, organic amines, diamines and amides, phosphines and phosphites, nitriles, triazoles, diaziridines and oximes.

The inhibitor content of the compositions of the present invention is preferably in the range from 0 to 50,000 ppm, more preferably in the range from 50 to 2000 ppm and especially in the range from 100 to 800 ppm.

Examples of further materials (F) are fillers, for example nonactive fillers other than the materials (D), materials to improve the surface properties such as adhesion promoters, reactive diluents, viscosity modifiers, processing assistants, for example plasticizers, pigments, UV absorbers, soluble dyes, scents, fungicides, purely organic resins, corrosion inhibitors, oxidation inhibitors, thermostabilizers, solvents, agents to influence the electrical properties, such as conductive carbon black, flame retardants, photoprotectants and agents to extend the skinning time, component (F) preferably also being an adhesion promoter.

Examples of nonreinforcing fillers which can be employed as further materials (F) and are different from component (D) are quartz flour, calcium silicate, zirconium silicate, zeolites, metal oxide powders, such as aluminum oxide, titanium oxide, iron oxide or zinc oxide, barium silicate, calcium carbonate and if appropriate calcium sulfate and barium sulfate when an inhibiting effect can be ruled out, and also polymeric powders, such as polyacrylonitrile powder or polytetrafluoroethylene powder. Useful fillers further include fibrous components, such as glass fibers and polymeric fibers. The BET surface area of these fillers is preferably less than 50 m²/g. Examples of plasticizers useful as component (F) are trimethylsilyl or hydroxy-terminated polydimethylsiloxanes having a viscosity of not more than 1000 mm²/s at 25° C. or else diphenylsilanediol.

Examples of adhesion promoters are epoxysilanes, methacryloyloxysilanes or polysiloxanes.

Examples of thermostabilizers are transition metal fatty acid salts, such as iron octoate, transition metal silanolates, such as iron silanolate, and also cerium(IV) compounds.

When additional fillers are used, the amounts in question are preferably in the range from 1 to 20 parts by weight and more preferably in the range from 2 to 5 parts by weight, all based on the total formulation of 100 parts by weight.

It is additionally possible to employ water and solvents such as, for example, toluene, xylene, benzines and ethyl acetate, but it is preferable to employ neither water nor solvent:

The compositions of the present invention can if necessary be dissolved, dispersed, suspended or emulsified in liquids such as solvent or water. The compositions of the present invention can, especially according to the viscosity of the constituents and also the filler content, be of low viscosity and pourable, have a pasty consistency, be pulverulent or else constitute pliant, high-viscosity compositions, similarly to the compositions known as RTV-1, RTV-2, LSR and HTV.

The mixing operation to produce the compositions of the present invention is preferably incorporation by comparatively strong shearing. Depending on the consistency and viscosity of the base medium, the mixing operation can be effected using roll systems, kneaders, dissolvers, Z-mixers, ball mills or simple stirrers. The mixing process is preferably carried out at ambient pressure, if only for simplicity. However, mixing at reduced or elevated pressure is also possible. Similarly for simplicity, the mixing operation is preferably carried out at ambient temperature. It is also possible to mix at elevated temperature or with cooling.

The compositions of the present invention have the advantage that they are simple to manufacture and readily processable. Additionally the compositions of the present invention have the advantage that vulcanizates can be produced, containing both dry hand properties with low coefficient of friction and increased share hardness.

The compositions of the present invention can be allowed to crosslink under the same conditions as prior art crosslinkable compositions based on organosilicon compounds. All common operations for processing silicone rubbers can be employed as manufacturing processes. Examples of common operations for processing silicone rubbers are calendering, compression molding, injection molding, extrusion and casting.

The present invention further provides shaped articles produced by using the compositions of the present invention.

The compositions of the present invention can also be used for coating textile sheetlike structures, such as wovens, formed-loop knits, no-crimp fabrics, drawn-loop knits, nonwovens, felts, etc. The coating can be applied by knife coating, dipping, extrusion or spraying. In addition, all types of roller coatings, such as engraved rolls, padding or application via multiroll systems and also screen printing are possible.

The coated wovens can be employed wherever reduced surface friction, opacity, reduced thermal value and in the case of topcoat applications a high tear strength and tensile strength are advantageous. Examples are hang gliders, parachutes, hot air balloons, leisure clothing, leisure articles such as tents or rucksacks, sails or airbags. In the industrial sector, the coated wovens are advantageously employed for conveyor belts, compensators, awnings, textile construction or in the insulation sector.

The present invention further provides textile or nontextile sheetlike structures coated with the compositions of the present invention.

Crosslinking of the compositions of the present invention gives vulcanizates which advantageously have good adhesion and a surface having a reduced coefficient of friction without aftertreatment. The vulcanizates of the present invention further have the advantage of a reduced heat value.

The compositions of the present invention that are crosslinkable by addition of Si bonded hydrogen onto aliphatic multiple bonding can be allowed to crosslink under the same conditions as the previously known compositions crosslinkable by hydrosilylation reaction. Preferably the temperatures involved range from 100 to 220° C., more preferably from 130 to 190° C., and the pressure ranges from 900 to 1100 hPa. However, it is also possible to employ higher or lower temperatures and pressures.

The compositions of the present invention and also the crosslinking products produced therefrom in accordance with the present invention can be used for any purpose for which organopolysiloxane compositions crosslinkable to form elastomers, and elastomers, may be used. This comprises in particular silicone coating, the production of shaped parts, for example in the injection molding process, vacuum extrusion process, extrusion process, shape casting and compression molding, and duplicate moldings, the use as sealing, embedding and potting compounds, etc.

It was found that, surprisingly, when a mixture consisting of solid particles of differing morphology, which is preferably round or laminar, different size ratios, compositions and partial surface functionalization is used in silicone rubber compositions or silicone rubber coatings for textile fabrics, films or other substrates, a marked improvement of simultaneously several product properties compared to existing systems comprising just an oval to spherical solid, just a natural, laminar solid and the customary reinforcing fillers can be achieved.

The particular solids composition of the composition of the present invention is distinguished as follows:
(1) the coefficient of friction of the vulcanizate of the composition of the present invention is significantly reduced compared with the customary, non-particle-modified silicone rubber for substantially the same adhesion. The reduction in the coefficient of friction is not less than 10%, preferably 20% and more preferably up to 80%,
(2) the adhesion to silicone rubber coated substrates and to noncoated textile substrates is not significantly below that of a coating free of laminar solids, and preferably is higher, and achieves at least the adhesion of a vulcanizate having exclusively spherical fractions coupled at the same time with a lower coefficient of friction for the vulcanizate as also known in some cases for coatings rich in natural sheet-silicates,
(3) the viscosity ranges from 1000 to 1,000,000 mpas, preferably 5000 to 100,000 with particular preference of a dilatant and rheopexic behavior of the basically low-viscosity composite rubber having very good proccssability.

### EXAMPLES

In the following examples of compositions in accordance with the present invention, all parts and percentages are by weight, unless otherwise stated. Similarly unless otherwise stated the examples which follow are carried out at a pressure of the ambient atmosphere, i.e., at about 1000 hPa, and at room temperature, i.e., about 20° C. or a temperature which results when the reactants are added together at room temperature without additional heating or cooling. All viscosity data in the examples shall relate to a temperature of 25° C.

Base Formulation 1 (B-1)

83 g of a vinyl-terminated dimethylpolysiloxane having a viscosity of 1000 mPas are mixed with 55 g of a siliceous filler to form a polymer-filler-base. A laminar solid was incorporated by shearing with 20 g of a sheet-silicate (fine-grained talc) and 20 g of an aluminum hydrate by means of a dissolver operating at circumferential speeds of not less than 12 m/sec for the dissolver disk. Into this millbase batch were incorporated 6 g of a tetraethyl silicate, 0.4 g of trimethylsilanol and 1.2 g of platinum catalyst (platinum 1,3 divinyl-1,1,3,3-tetramethyldisiloxane complex with 1% by weight of Pt), 10 g of a methylhydrogenpolysiloxane with an adhesion promoter (hydrogen content is 1.25% by weight, viscosity is 10 to 20 mPas) and 0.6 g of ethynylcyclohexanol. The viscosity is 51,600 mPas.

Base Formulation 2 (B-2)

In lieu of the laminar, fine-grained extender, 80 g of a more coarse-grained aluminosilicate filler having a predominantly spherical morphology was sheared into the base formulation (B-1) for a comparable viscosity of 48,800 mPas.

The resulting silicone rubber compositions (B-1) and (B-2) were vulcanized at 180° C. within 3 minutes.

### Example 1

(BE-1), Optimized Formulation With Talc as Filler

128 g of polymer base from vinyl-terminated dimethylpolysiloxane having a viscosity of 1000 mPas and nonfunctionalized siliceous filler are thoroughly mixed with additional 70 g of dimethylpolysiloxane and 110 g of fine-grained laminar solid (finely ground talc) by means of a dissolver using circumferential speeds of not less than 12 m/s for the dissolver disk. Into this millbase batch were incorporated 22.6 g of a 1-dodecene, 6 g of a tetraethyl silicate, 0.4 g of trimethylsilanol and 1.2 g of platinum catalyst (platinum 1,3 divinyl-1,1,3,3-tetramethyldisiloxane complex with 1% by weight of Pt), 10 g of a methylhydrogenpolysiloxane with an adhesion promoter (hydrogen content of 1.25% by weight, viscosity of 10 to 20 mPas) and 0.6 g of ethynylcyclohexanol. The viscosity was 53,600 mPas.

### Example 2

(BE-2), Formulation With Mica as Filler

In lieu of the fine-grained talc 56 g of a coarse-grained muscovite mica were sheared into the example formulation (BE-1) for a comparable viscosity of 57,200 mPas.

### Example 3

(BE-3), Formulation With Spherical Particles as Filler

In lieu of the fine-grained talc, 16 g of nanoscale spherical particles based on silica were sheared into the example formula (BE-1) for a comparable viscosity of 50,800 mPas.

### Example 4

(BE-4), Formulation With Spherical Particles as Filler

In lieu of the finely granular talc 210 g of μm size predominantly spherical particles based on aluminosilicate were sheared into the example formulation (BE-1) for a comparable viscosity of 48,400 mPas.

### Example 5

(BE-5), With Optimized Polymer-Filler-Base and Spherical Particles as Filler

The example formulation (BE-1) had incorporated into it a modified polymer-filler-base (128 g) consisting of vinyl-terminated dimethylpolysiloxane having a viscosity of 1000 mPas and reinforcing functionalized laminar calcined solid. In lieu of fine-grained talc as filler, 335 g of μm size predominantly spherical particles based on aluminosilicate were sheared in for a comparable viscosity of 64,400 mPas.

### Example 6

(BE-6), With Modified Polymer-Filler-Base and Spherical Particles as Filler

The example formulation (BE-5) had incorporated into it a modified polymer base (128 g) consisting of vinyl-terminated dimethylpolysiloxane having a viscosity of 1000 mPas and nonfunctionalized laminar calcined solid. The amount of sheared-in predominantly spherical particles based on aluminosilicate as filler is 390 g. The viscosity is 53,600 mPas.

### Example 7

(BE-7), With Modified Polymer-Filler-Base and Spherical Solid as Filler

The example formulation (BE-5) had incorporated into it a modified polymer base (128 g) consisting of vinyl-terminated dimethylpolysiloxane having a viscosity of 1000 mPas and reinforcing functionalized laminar calcined solid combined with nonfunctionalized siliceous filler. The amount added of sheared-in predominantly spherical particles based on aluminosilicate as filler is 300 g. The viscosity is 53,600 mPas.

### Example 8

(BE-8), With Modified Polymer-Filler-Base and Spherical Particles as Filler

The example formulation (BE-5) had incorporated into it a modified polymer base (128 g) consisting of vinyl-terminated dimethylpolysiloxane having a viscosity of 1000 mPas and a reinforcing functionalized laminar calcined solid combined with nonfunctionalized siliceous filler. Different from (BE 5), 22.6 g of 1-dodecene were replaced by 8.0 g of trimethoxyisooctylsilane. The amount of sheared-in, predominantly spherical particles based on aluminosilicate as filler is 300 g. The viscosity is 51 200 mPas.

### Example 9

(BE-9), With Modified Polymer-Filler-Base and Spherical Particles as Filler

The example formulation (BE-5) had incorporated into it a modified polymer base (128 g) consisting of vinyl-terminated dimethylpolysiloxane having a viscosity of 1000 mPas and reinforcing functionalized laminar aluminosilicatic solid combined with nonfunctionalized silicatic filler. In deviation from (BE 5), 22.6 g of 1-dodecene were replaced by 8.0 g of triethoxyisooctylsilane. The amount added of sheared-in predominantly spherical particles based on aluminosilicate as effect filler is 300 g. The viscosity is 72 000 mPas.

The resulting silicone rubber compositions (BE-1 to BE-9) were vulcanized at 170° C. within 2 minutes.

Measured Results:

The composition of the present invention was tested as a topcoat and as a basecoat. In what follows, the results of determining adhesion and coefficient of friction of topcoated fabrics are presented.

The base coated nylon fabric (S-1 to S-2) was tested for comparison without a topcoat of the composition of the present invention and, as documented in examples (B-1 to B-2) and (BE-1 to BE-9), with topcoats of the compositions of the present invention. The measurements on adhesion were carried out in accordance with DIN 53530 and the measurements for determining the coefficient of friction (static/dynamic) of the vulcanizate were carried out in accordance with DIN 53375. The measured results are documented in Table 1.

All the tests were carried out on basecoated nylon fabric (substrate), the basecoat consisting of Elastosil LR 6250 F (commercial product of Wacker Chemie AG). The basecoat add-on is about 60 g/m². The fabrics were topcoated by knife coating.

The comparative examples (S1-S2) are substrates not topcoated with the composition of the present invention:

(S-1): basecoated nylon fabric without topcoat.

(S-2): basecoated nylon fabric topcoated for comparison with Elastosil EL 47005 (commercial product of Wacker Chemie AG).

The base formulations (B-1 to B-2) and the examples (BE-1 to BE-4) with optimized recipe and examples (BE-5 to B-9) with optimized formulation and optimized polymer-filler-base gave silicone rubbers having the following properties:

TABLE 1

| | | | | Coefficient of |
|---|---|---|---|---|
| Composition | Filler Variation | Add-on | Adhesion | friction (COF) |
| S-1 | — | no TC* | 132 | 1.20/1.07 |
| S-2 | — | TCI*, 29 | 89 | 0.86/0.73 |
| B-1 | talc, finely | 29 | 62 | 1.64/1.65 |
| | laminar | | | |
| B-2 | aluminosilicate | 33 | 162 | 1.00/0.80 |
| | spherical (μm) | | | |
| BE-1 | talc, finely | 14 | 44 | 0.65/0.62 |
| | laminar | | | |
| BE-2 | muscovite, | 16 | 76 | 0.59/0.58 |
| | coarsely laminar | | | |
| BE-3 | quartz spherical | 19 | 128 | 0.89/0.83 |
| | (nm) | | | |
| BE-4 | aluminosilicate | 19 | 177 | 0.54/0.49 |
| | spherical (μm) | | | |
| BE-5 | aluminosilicate | 14 | 195 | 0.63/0.59 |
| | spherical (μm) | | | |
| | modified | | | |
| | foundation stock | | | |
| BE-6 | aluminosilicate | 18 | 129 | 0.70/0.63 |
| | spherical (μm) | | | |
| | modified | | | |
| | foundation stock | | | |
| BE-7 | aluminosilicate | 16 | 183 | 0.49/0.42 |
| | spherical (μm) | | | |
| | modified | | | |
| | foundation stock | | | |
| BE-8 | aluminosilicate | 13 | 240 | 0.51/0.47 |
| | spherical (μm) | | | |
| | modified | | | |
| | foundation stock | | | |
| BE-9 | aluminosilicate | 17 | 188 | 0.48/0.47 |
| | spherical (μm) | | | |
| | modified | | | |
| | foundation stock | | | |

no TC* = no topcoat,
*TC1 = with Elastosil EL 47005 topcoat

In what follows, basecoats with average add-ons from 50 to 65 g/m² are presented.

The tests were carried out on uncoated nylon fabric. The fabrics were coated by knife coating. The uncoated original nylon fabric was provided with basecoats of the compositions of the present invention which are documented by the BE-10 to BE-15 examples. The adhesion measurements were carried out in accordance with DIN 53530 and the measurements to determine the coefficient of friction (static/dynamic) of the vulcanizate were carried out in accordance with DIN 53375. The measured results are shown in Table 2.

The comparative example (S-3) is a substrate (nylon fabric) coated with a basecoat consisting of Elastosil EL LR 6250 F (commercial product of Wacker Chemie AG).

The examples (BE-10) to (BE-13) with optimized formulation and the examples (BE-14) to (BE-15) with optimized formulation and optimized polymer-filler-base gave silicone rubbers having the following properties:

### Example 10

(BE-10), Formulation With Muscovite Mica as Filler

128 g of a polymer-filler-base from vinyl-terminated dimethylpoly-siloxane having a viscosity of 1000 mPas and nonfunctionalized silaceous filler have additionally sheared into them 70 g of dimethylpolysiloxane and 60 g of a coarse-grained sheet-silicate (muscovite) using a dissolver at circumferential speeds of not less than 12 m/sec for the dissolver disk. Into this millbase batch are incorporated 22.6 g of a 1-dodecene, 6 g of a tetraethyl silicate, 0.4 g of trimethylsilanol and 1.2 g of platinum catalyst (platinum 1,3-divinyl-1,1,3,3-tetramethyldisiloxane complex with 1% by weight of Pt), 10 g of a methylhydrogenpolysiloxane with an adhesion promoter (hydrogen content of 1.25% by weight and viscosity of 10 to 20 mPas) and 0.6 g of ethynylcyclohexanol. The viscosity is 74,000 mPas.

### Example 11

(BE-11), Formulation With Biotite as Filler

In lieu of the muscovite, 80 g of a coarse-grained biotite were sheared into the example formulation (BE-10) with a resulting viscosity of 46,000 mPas.

### Example 12

(BE-12), Formulation with Nanoscale Spherical Particles as Filler

In lieu of the laminar solid (coarse-grained muscovite), 16 g of nanoscale spherical particles based on silica were sheared into the example formulation (BE-10) with a comparable viscosity of 60,000 mPas.

### Example 13

(BE-13), Formulation With a Filler Batch Consisting of Laminar and Spherical Extenders

In lieu of the muscovite, 95 g were sheared into the example formulation (BE-10) of a batch consisting of a laminar solid (fine-grained talc) and substantially spherical aluminosilicate particles in a ratio of 1:1 with a resulting viscosity of 42 000 mPas.

### Example 14

(BE-14), Formulation With Modified Polymer-Filler-Base and With Spherical Particles as Filler

Deviating from the example formulation (BE-10), a modified polymer-filler-base (128 g) consisting of vinyl-terminated dimethylpolysiloxane having a viscosity of 1000 mPas and a reinforcing functionalized laminar calcined filler was used. Furthermore, in lieu of the coarse-grained muscovite as effect filler 335 g of μm size spherical particles based on aluminosilicate were sheared in for a resulting viscosity of 64,400 mPas.

### Example 15

(BE-15), Formulation with Modified Polymer-Filler-Base and with Spherical Particles as Filler

Different from the example formulation (BE-14), a modified polymer-filler-base (128 g) consisting of vinyl-terminated dimethylpolysiloxane having a viscosity of 1000 mPas and reinforcing functionalized laminar calcined solid combined with nonfunctionalized siliceous filler was used. The amount added of sheared-in predominantly spherical particles based on aluminosilicate as effect filler is 300 g. The viscosity is 53,600 mPas.

TABLE 2

| | | | | Coefficient of |
|---|---|---|---|---|
| | | Add-on | Adhesion | friction (COF) |
| Composition | Filler Variation | g/m² | N/5 cm | static/kinetic |
| S-3 | — | 55 | 232 | 1.2/0.98 |
| BE-10 | muscovite, coarsely | 61 | 68 | 0.33/0.20 |
| | laminar | | | |
| BE-11 | biotite coarse, | 59 | 47 | 0.26/0.20 |
| | laminar | | | |
| BE-12 | quartz | 52 | 203 | 0.35/0.28 |
| | spherical (nm) | | | |
| BE-13 | aluminosilicate (μm) | 52 | 115 | 0.44/0.34 |
| | spherical + talc | | | |
| | laminar (1:1) | | | |
| BE-14 | aluminosilicate | 59 | 178 | 0.27/0.20 |
| | spherical (μm) | | | |
| | modified | | | |
| | polymer-filler-base | | | |
| BE-15 | aluminosilicate | 61 | 151 | 0.21/0.14 |
| | spherical (μm) | | | |
| | modified | | | |
| | polymer-filler-base | | | |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A composition comprising:
an addition-crosslinking organosilicon composition;
at least one oval to sphere-shaped solid filler and at least one laminar solid filler;
and at least one component (E):
(E1) hydrocarbyl compound(s) having at least 8 carbon atoms, optionally interrupted heteroatoms N, O, P or S, free valences of the heteroatoms being saturated by hydrogen or monovalent hydrocarbyl radicals;
(E2) silane(s) of the formula
(RO)₄₋ₙSiXₙ
where R is a monovalent hydrocarbyl radical having up to 16 carbon atoms and X independently of R has the meaning of R or is a functional hydrocarbyl radical having 1 to 6 carbon atoms between an organic functional group and the silicon atom, the organic functional group comprising an epoxy group or a methacryloyloxy group;
(E3) an organozirconium or organotitanium compound of the general formula
(RO)₄₋ₙMXₙ
where R and X are each as defined above and M is Ti or Zr; and optionally,
(E4) an organic solvent,
the coefficient of friction of the vulcanizate being reduced compared with a preparation without particles (D).

2. The composition of claim 1, wherein component (E) is a silane of the formula (RO)₄₋ₙSiXₙ where R is methyl or ethyl, n is 1 and X is C₈₋₁₂ hydrocarbyl.

3. The composition of claim 1, wherein the oval to sphere-shaped or laminar solid, or both, is functionalized by a surface coating of silane of the general formula
R₄₋ₙSiXₙ
where R is an alkoxy or hydroxy group, n is 1, 2 or 3 and X is alkyl, epoxy, vinyl, (meth)acryloyl or hydroxyl, with the proviso that the organic function is directly bonded to the silicon atom or is remote from the silicon atom by a spacer of 1-12 carbon atoms.

4. The composition of claim 1, wherein the oval to sphere-shaped solids have an average particle size of 10 nm-100 μm.

5. The composition of claim 1, wherein the laminar solids have a length to thickness (L/T) ratio of 5 to 200.

6. The composition of claim 1, wherein the ratio of oval to sphere-shaped particles:laminar particles is in the range from 1:20 to 20:1.

7. The composition of claim 1, wherein the ratio of laminar:oval to sphere-shaped particles is in the range from 1:10 to 10:1.

8. The composition if claim 1, wherein the minimum weight fraction of oval to sphere-shape particles and laminar particles relative to the weight of the overall formulation is 15%.

9. The composition of claim 1, wherein the weight fraction of oval to sphere-shaped particles and laminar particles relative to the weight of the overall formulation is 30-50%.

10. The composition of claim 1, wherein the weight fraction of oval to sphere-shaped particles and laminar particles relative to the weight of the overall formulation is 50-90%.

11. The composition of claim 1, which has a viscosity of 100-500,000 mPas at 25° C.

12. In a process of coating a substrate with an addition curable organopolysiloxane composition to reduce friction, the improvement comprising employing a composition of claim 1.

13. A molded article comprising a composition of claim 1.

14. A textile or nontextile sheetlike structure comprising a composition of claim 1.

15. A textile article having a coating comprising a composition of claim 1 coated thereon.
